(19) United States
(12) Patent Application Publication
(10) Pub. No.: US 2005/0225165 A1
(43) Pub. Date: Oct. 13, 2005

(54) Brake by-wire control system

(76) Inventors: Sanjeev M. Naik, Troy, MI (US); Pradyumna K. Mishra, Royal Oaks, MI (US); Thomas E. Fuhrman, Shelby Township, MI (US); Mark N. Howell, Rochaester Hills, MI (US); Rami I. Debouk, Dearborn, MI (US); Mutasim a. Salman, Rochester Hills, MI (US)

Correspondence Address: KATHRYN A MARRA;General Motors Corporation, Legal Staff, Mail Code 482-C23-B21, P.O. Box 300, Detroit, MI, 48265-3000, US

(21) Appl. No.: 10/823,469

(22) Filed: Apr. 13, 2004

(51) Int. Cl. B60T 13/66

(52) U.S. Cl. 303/20

(57) ABSTRACT

A brake control system for brake by wire applications having a dual fail-silent pair controller architecture. The system utilizes two supervisory controllers and a shared monitoring controller to achieve the dual fail-silent pair configuration. The brake control system also features a mechanism whereby the monitoring controller ensures the fail-silent operation of the brake control units in the event of certain undesired events occurring within the system by assuming control of the affected brake control units. The control system further assures that no single event, including an event related to the monitoring controller, causes loss of more than half the braking functionality. The control system also features additional redundancy with regard to the brake command signals by sharing a separate unprocessed brake command signal with each of the supervisory controllers and the monitoring controller.

### TECHNICAL FIELD

This invention generally relates to vehicle control systems. More particularly, this invention relates to fault-tolerant by-wire vehicle control systems. Most particularly, this invention relates to fault-tolerant by-wire brake control systems.

### BACKGROUND OF THE INVENTION

Brake by wire brake control systems provide a number of advantages with regard to brake system packaging. The associated electronic control systems and the implementation of advanced computer control algorithms facilitate a number of new brake control features. However; such systems also typically remove any direct mechanical or hydraulic force transmitting path between the vehicle operator and the brake control units. Therefore, much attention has been given to designing brake by wire brake control systems and control architectures that ensure robust operation. General design techniques which have been employed in such systems are redundancy, fault tolerance to undesired events (e.g., events affecting control signals, data, hardware, software or other elements of such systems), fault monitoring and recovery, to determine if and when such an event has occurred and take or recommend action to ensure braking control of the vehicle. One design approach to provide fault tolerance which has been utilized in brake by wire brake control systems has been to design control systems and control architectures which ensure that no single event occurring in the system will cause a complete loss of the brake control of the vehicle.

FIG. 1 schematically illustrates a related art brake by wire brake control system 10. System 10 is a fail-silent pair brake control system. The brake control system 10 generally comprises a pair of substantially identical brake controllers 20,22. Each of controllers 20,22 is adapted to control the braking of two of road wheels 26,28,30,32. In the configuration shown, controller 20 is adapted to control the braking of front road wheels 26,28 and controller 22 is adapted to control the braking of rear road wheels 30,32. Braking of road wheels 26,28,30,32 is performed through the operation of brake controls 34,36,38,40, respectively. Controller 20 is in signal communication with brake controls 34,36 and controller 22 is in signal communication with brake controls 38,40. Controllers 20,22 comprise a pair of substantially identical brake control modules 40,42 and 44,46, respectively. Brake control modules 40,42 and 44,46 are adapted to provide redundant control of brake controls 34,36 and 38,40, respectively, through control bus 48 and control bus 50. Controllers 20,22 and their respective control modules 40,42 and 44,46 and brake controls 34,36 and 38,40 are of a fail-silent design, such that they either produce the correct result at the correct time or they produce no control result at all. Controllers 20,22 and their respective control modules 40,42 and 44,46 are also in signal communication with one another through control bus 52. Each controller is adapted to monitor the status of its control modules and the other controller and its control modules, particularly so as to detect any undesired events associated with one of the control modules. In this configuration, each controller has dual redundancy and the system is adapted to provide at least half of its braking function in response to any single event, whether it be in a controller/control module, communication bus or brake controller. While the system shown in FIG. 1 provides a generally acceptable level of redundancy and fault tolerance with regard to single point events, the cost and system complexity associated with dual controllers and dual control modules remains undesirably high.

Similarly, FIG. 2 illustrates a related art brake control system 60 having dual redundancy with respect to controllers 62 and 64 and triple modular redundancy with respect to control modules 66,68,70 and 72,74,76, respectively. This design generally provides a greater degree of redundancy and fault tolerance with regard to undesired events associated with the controllers; however, it also has the same disadvantage of the added cost and system complexity associated with dual controllers as the design of FIG. 1, and even greater cost and complexity associated with triple redundancy among the control modules.

Therefore, it is desirable to identify a brake control system and control architecture which provides system level redundancy and fault tolerance with reduced system complexity, particularly a reduced number of controllers and control modules as compared to related art systems.

### SUMMARY OF THE INVENTION

The present invention comprises a brake control system and control architecture which provides system level redundancy and fault tolerance with reduced system complexity, particularly a reduced number of controllers and control modules as compared to previous brake control systems.

The key features of the control system and architecture of the present invention are flexibility and simplicity. The architecture is flexible enough to allow front/rear pair braking which is frequently desirable for use in cars, as well as diagonal pair braking which is frequently desirable for use in trucks. The simplicity stems from the fact that three controllers are used to achieve two fail-silent pairs of controllers through the sharing of one monitoring controller. The system also features a mechanism whereby the monitoring controller ensures fault tolerance and the fail-silent operation of the brake control units if an undesired event occurs in either of the supervisory controllers or the communication buses which provide signal communication between the supervisory controllers and the brake controls.

The control system also features additional redundancy with regard to the brake command signals. The system utilizes three raw brake pedal sensor signals to produce a processed brake command signal as is known. However, each one of the three raw brake command signals is also provided to one of the three controllers together with the processed brake command signal, thereby enabling enhanced redundancy and fault tolerance with respect to the determination of the brake command signal.

### BRIEF DESCRIPTION OF THE DRAWINGS

The present invention will be more fully understood from the accompanying drawings, in which:

FIG. 1 is a schematic illustration of a first brake control system of the prior art;

FIG. 2 is a schematic illustration of a second brake control system of the prior art;

FIG. 3 is a schematic illustration of a brake control system of the present invention having front/rear separation of the brake control function and,

FIG. 4 is a schematic illustration of a brake control system of the present invention having diagonal separation of the brake control function; and,

FIG. 5 is a block diagram of a mechanism to ensure the fail-silent operation of the brake control units.

### DESCRIPTION OF THE PREFERRED EMBODIMENT

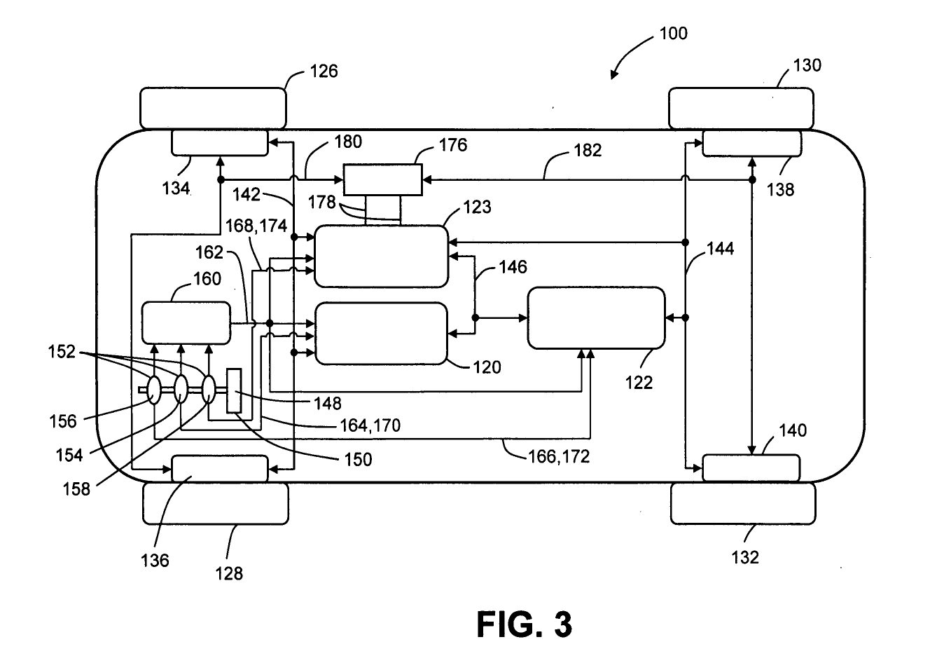

FIG. 3 illustrates an embodiment of a brake by wire brake control system 100 of the present invention. Described generally, brake control system 100 and its constituent parts comprise a fail-silent brake control system, such that it either provides the correct brake control command and result at the correct time, or it provides no control result at all. Brake control system 100 generally comprises two substantially identical supervisory brake controllers 120,122 and a monitoring controller 123. Controllers 120,122,123 may be incorporated into a single controller as separate control modules or portions thereof. However, it is believed to be preferred to implement controllers 120,122,123 as shown in FIG. 3 as separate and distinct controllers or control modules to provide additional protection against common mode events. Each of supervisory controllers 120,122 is adapted to control the braking of a pair of road wheels 126,128,130,132. The embodiment shown in FIG. 3 illustrates a front pair/rear pair arrangement. Supervisory controller 120 is adapted to control the braking of the pair comprising right front road wheel 126 and left front road wheel 128 and supervisory controller 122 is adapted to control the braking of the pair comprising right rear road wheel 130 and left rear road wheel 132. Braking of road wheels 126,128,130,132 is performed through the operation of their respective brake control units 134,136,138,140. Supervisory controller 120 is in signal communication with brake control units 134,136 through a first brake control bus 142 to which it is operatively connected. Supervisory controller 122 is in signal communication with brake controls 138,140 through a second brake control bus 144 to which it is operatively connected. As used herein, the term operatively connected is intended broadly to comprise all of the connections, including mechanical, electrical, optical or other connections, necessary to enable the operation of one constituent element of system 100 with another. The term signal communication is intended to encompass all forms of signals and methods of communicating signals from one element of system 100 to another. Supervisory controllers 120,122 and monitoring controller 123 are each in signal communication with one another through controller bus 146 and are each operatively connected to it. Brake control system 100 also comprises a brake actuation device 148, such as brake pedal 150. Brake pedal 150 is operatively connected to a plurality of brake sensors 152 for sensing an operator input, such as brake sensors 154, 156 and 158. Brake sensors 154,156,158 are each in signal communication with and operatively connected to brake actuator module 160 which is adapted to receive unprocessed signals from brake sensors 154,156,158 and produce a processed brake signal 162 therefrom. Brake actuation module 160 is operatively connected to a signal line which is also operatively connected to each of controllers 120,122,123, such that brake actuation module 160 is in signal communication and adapted to provide processed brake signal 162 to each of controllers 120,122,123. Brake sensors 154,156,158 are each also operatively connected to raw or unprocessed sensor signal lines 164,166,168, respectively which are also operatively connected to controllers 120,122,123, respectively, such that each is in signal communication with its respective controller and is adapted to provide its respective raw sensor signal 170,172,174, thereto. It is preferred that system 100 also incorporate brake control cutoff module 176. Brake control cutoff module 176 is operatively connected to at least one controller signal line 178 which is also operatively connected to controlling monitor 123, such that controlling monitor 123 is in signal communication with and adapted to provide a control input to brake control cutoff module 176. Brake control cutoff module 176 is also operatively connected to a first brake control signal line 180 which is also operatively connected to each of the respective ones of the first pair of brake control units 134,136 such that brake control cutoff module is in signal communication with and adapted to provide an output signal to the first pair of brake control units 134,136. Brake control cutoff module 176 is also operatively connected to a second brake control signal line 182 which is also operatively connected to each of the respective ones of the second pair of brake control units 138,140 such that brake control cutoff module is in signal communication with and adapted to provide an output signal to the second pair of brake control units 138,140. It is believed that control system 100 of the present invention may also be adapted to implement certain features of the control system and method disclosed in related, commonly assigned, co-pending U.S. patent application Ser. No. ______ (Attorney Docket No. GP-303743) filed on even date herewith, which is hereby incorporated herein by reference in its entirety.

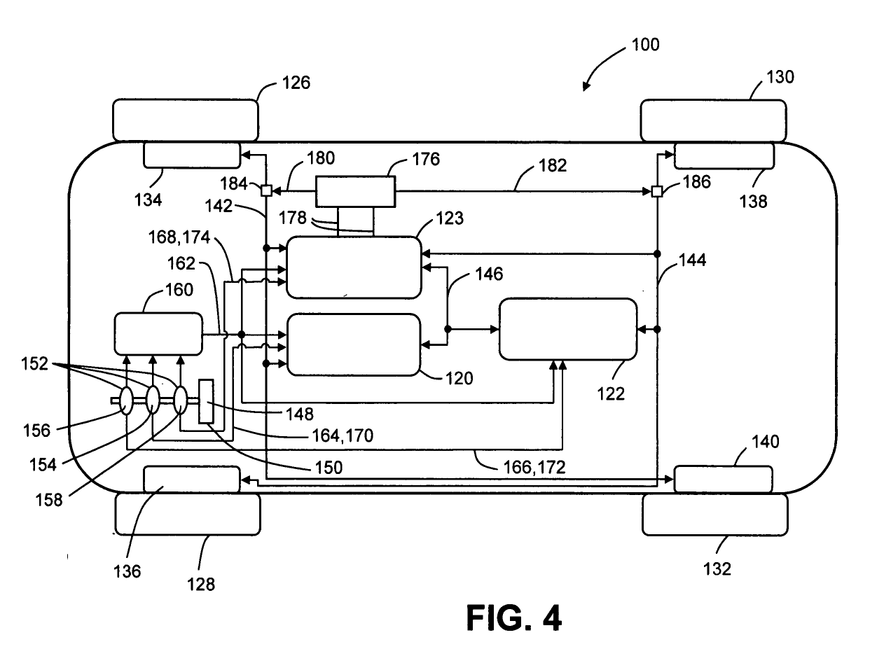

A second embodiment of system 100 is illustrated in FIG. 4. Referring to FIG. 4, each of controllers 120,122 is adapted to control the braking of a pair of road wheels 126,128,130,132. The embodiment shown in FIG. 4 illustrates a cross diagonal pair arrangement. Controller 120 is adapted to control the braking of the diagonal pair comprising right front road wheel 126 and left rear road wheel 132 and controller 122 is adapted to control the braking of the diagonal pair comprising right rear road wheel 130 and left front road wheel 128. Braking of road wheels 126,128,130,132 is performed through the operation of their respective brake control units 134,136,138,140. Controller 120 is in signal communication with brake control units 134,140 through a first brake control bus 142 to which it is operatively connected. Controller 122 is in signal communication with brake controls 136,138 through a second brake control bus 144 to which it is operatively connected. Supervisory controllers 120,122 and monitoring controller 123 are each in signal communication with one another through controller bus 146 and are each operatively connected to it. Brake control system 100 also comprises a brake actuation device 148, such as brake pedal 150. Brake pedal 150 is operatively connected to a plurality of brake sensors 152 for sensing an operator input, such as brake sensors 154, 156 and 158. Brake sensors 154, 156, 158 are each in signal communication with and operatively connected to a brake actuator module 160 which is adapted to produce a processed brake signal 162. Brake actuator module 160 is operatively connected to a signal line which is also operatively connected to each of controllers 120,122,123, such that brake actuator module 160 is in signal communication and adapted to provide processed brake signal 162 to each of controllers 120,122,123. Brake sensors 154,156,158 are each also operatively connected to a raw sensor signal line 164,166,168 which is also operatively connected to controllers 120,122,123, respectively, such that each is in signal communication with its respective controller and is adapted to provide its respective raw sensor signal 170,172,174, thereto. It is preferred that system 100 also incorporate brake control cutoff module 176. Brake control cutoff module 176 is operatively connected to at least one controller signal line 178 which is also operatively connected to controlling monitor 123, such that controlling monitor 123 is in signal communication with and adapted to provide a control input to brake control cutoff module 176. Brake control cutoff module 176 is also operatively connected to first brake control signal line 180 which is also operatively connected to first brake control bus 142 at a first bus control 184 such that brake control cutoff module 176 is in signal communication with and adapted to provide an output signal to first bus control 184. Brake control cutoff module 176 is also operatively connected to second brake control bus 144 at a second bus control 186 such that brake control cutoff module is in signal communication with and adapted to provide an output signal to second bus control 186.

Referring to FIGS. 3 and 4, the features comprising the differences between these embodiments, namely the grouping of the control pairs front/back versus cross diagonal, and the connection of the brake control cutoff module to the brake control buses versus directly to the brake control units, may be interchanged in any combination. Having described the elements of system 100 and their general relationship to one another, these elements and to their function and operation with one another are discussed in greater detail below.

System 100 generally, and in particular controllers 120,122,123, comprises a real time distributed computing system. Supervisory controllers 120,122 comprise a pair of substantially identical supervisory brake control modules which supervise and perform the control of system 100, and monitoring controller 123 monitors the operation of system 100 and supervisory controllers 120,122. Controllers 120,122,123 are preferably substantially identical in construction with respect to their associated control hardware and components, however, they may implement somewhat different control algorithms, for example, to provide a distinction between the application of the front and rear brakes in the case of supervisory controllers 120,122, respectively, and to provide the system and controller monitoring function in the case of monitoring controller 123. Methods and control algorithms to provide differentiation of the braking function between front and rear brakes are known, as are methods to provide certain system monitoring and monitoring of supervisory controllers. Supervisory controllers 120,122 and monitoring controller 123 are of conventional construction and well known, such as the Motorola PowerPC series of controllers. This construction may, for example, comprise two basic control units, a communication control unit (CCU) and a computing unit (CU). The CCU may comprise a microcontroller having internal random-access memory (RAM) and an internal time-processing unit (TPU) that is well suited to perform the precise time measurements required by certain time-triggered communication protocols. The microcontroller may also comprise an internal data bus. The program of the microcontroller and the data structures that control the messages to be sent and received on the first brake control bus 142, second brake control bus 144 and controller bus 146 are contained in a form of read only memory (ROM). The messages are assembled and disassembled by an interface controller. The interface controller generates and receives the logical transmission signals from bus drivers that are connected to the buses 142,144,146. The interface between the CCU and the CU is generally realized by a digital output line and a form of shared memory, such as Dual Ported Random Access Memory (DPRAM), which can be accessed from both the CCU and the CU. The digital output line supplies a globally synchronized time signal to the CU from the CCU. This unidirectional signal is generally the only control signal that passes the interface between the CCU and the CU. The shared memory contains the data structures that are sent from the host CU to the CCU and vice versa as well as control and status information. The hardware architecture of the CU may generally comprise a central processing unit (CPU), RAM and an input/output unit that is adapted to provide input/output signals to the brake control units which control the braking function of these units. The devices of the CU are also generally interconnected by an industry standard bus. This is an exemplary description of controller architecture that is adapted for use in system 100 and controllers 120,122,123. Other controller architectures are also possible for providing control of system 100 and use in controllers 120,122,123 in accordance with the description provided herein.

Referring to FIG. 3, supervisory controllers or control modules 120,122 are supervisory, in that they provide control commands to and monitor the status of the implementation and performance of these control commands by their respective brake control units 134,136 and 138,40, respectively, through first brake control bus 142 and second brake control bus 144, respectively. Supervisory controllers 120,122 and their respective brake controls 134,136 and 138,140 are fail-silent, such that they either produce the correct result at the correct time or they produce no control result at all. Supervisory controllers 120,122 are also each in signal communication with one another and monitoring controller 123 through controller brake control bus 146.

Brake control buses 142,144 and controller bus 146 are conventional data communication buses, having associated communication protocols and communication interfaces, as are commonly used in vehicular applications and may be of the same construction. Brake control buses 142,144 and controller bus 146, may, however, comprise any suitable bus medium and communication protocol, including various forms of wireless communication methods and protocols. Examples of suitable buses/communication protocols include the MOST (Media Oriented Systems Transport) bus, SAE J1850 bus, byteflight bus, FlexRay bus, TTP bus, IDB-1394 (Intelligent Transportation System Data Bus) bus, and the CAN (Controller Area Network) bus.

It is preferred that monitoring controller 123 also be substantially identical to supervisory brake controllers 120,122 in order to reduce the overall system complexity and improve interoperability, however, monitoring controller 123 may also be specially adapted with respect to both hardware and software for the purpose of monitoring the performance of supervisory controllers 120,122 or providing for the control of brake controls units 134,136 and 138,140, as further described herein.

Referring to FIG. 3, brake control units 134,136,138,140 may be any brake control unit suitable for controlling the braking of road wheels 126,128, 130,132, respectively. Brake control units 134,136,138,140 may be of conventional construction and generally comprise a brake control module, brake actuator and brake member (not shown). The brake control module is adapted to receive control commands from one of controllers 120,122 and communicate information regarding the implementation and performance of these control commands back to the controllers. Control module is also adapted to control the brake actuator based on the control commands received from one of the controllers 120,122. Brake actuator may, for example, comprise an electric brake caliper having a caliper assembly that is actuated by operation of an electric motor or solenoid. The brake member may comprise various friction media as are well known that are in operable engagement with the electric caliper, and adapted for application by operation of the caliper to a brake disk that is mechanically coupled to road wheels. In another embodiment, brake control unit may comprise a brake control module that is adapted to control an electric drive that is in turn adapted to produce a counter torque to resist the motion of road wheels, and thereby provide for the braking of road wheels 126,128,130,132.

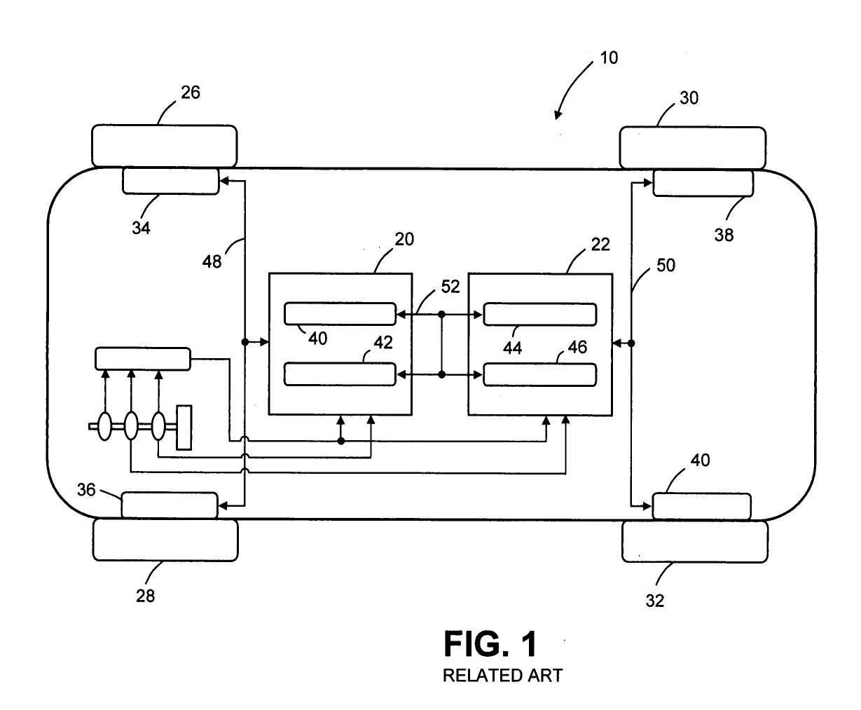

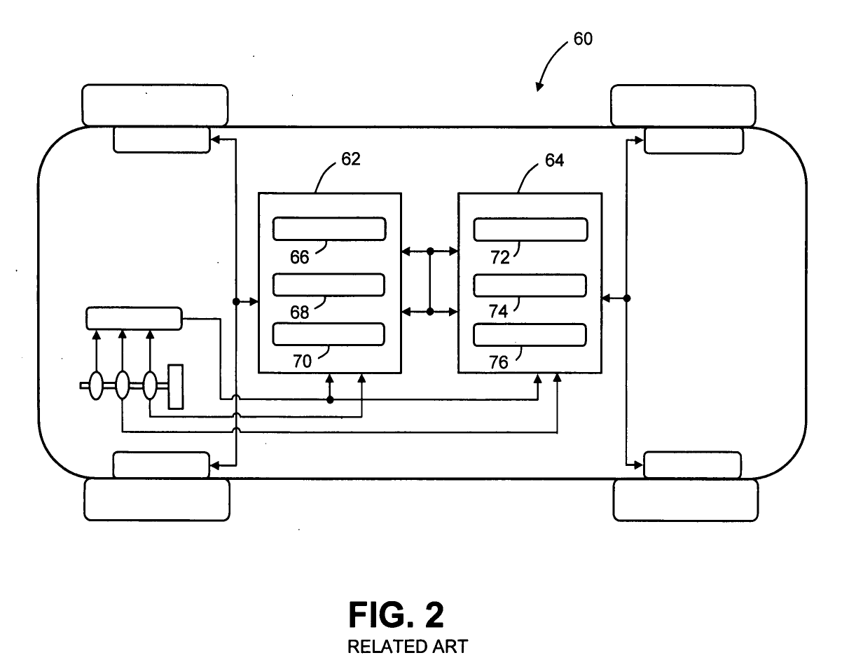

Referring to FIGS. 3 and 4, brake control system 100 also comprises a brake actuation device 148, such as brake pedal 150. Brake pedal 150 is operatively connected to a plurality of brake actuation sensors 152 for sensing an operator input and actuation of the brake actuation device 148, such as brake actuation sensors 154,156,158. Brake actuation sensors are of conventional construction, such as various forms of pressure, force or displacement sensors or transducers. Brake actuation sensors 154,156,158 are adapted to provide raw or unprocessed sensor output signals 170,172,174, respectively. Brake actuation sensors 154,156,158 are each operatively connected to a signal line which is in turn operatively connected to brake actuation module 160, such that each sensor is in signal communication with a brake actuation module 160. Brake actuation module 160 is operatively connected to a processed signal line 162 which is in turn operatively connected to each of controllers 120,122,123 such that module 160 is in signal communication with each of them. Brake actuation module 160 is adapted to provide processed brake signal 162 to each of controllers 120,122,123. Brake actuation module 160 is adapted to process the raw signals which are input from the sensors and determine a processed brake signal 162 that is representative of the command input from the operator. Brake actuation module 160 may be adapted to process the raw signals using any of a number of known techniques for detecting undesired events related to the raw input signals, such as the detection of erroneous or missing raw signals. Brake sensors 154,156,158 are also in signal communication with controllers 120,122,123, respectively, and are adapted to provide their respective raw sensors signals 164,166,168 to them over raw signal lines 170,172,174, respectively. It is preferred that the signal communication of both processed sensor signal 162 and raw sensor signals 164,166,168 be provided using hard-wire connections as opposed to a brake control bus or buses. The use of both raw and processed sensor signals has been utilized previously, as can be seen in FIGS. 1 and 2, to provide redundancy with respect to the sensed signal that is utilized by controllers 120,122 to develop the control command or commands associated with an operator input. The present invention also provides a third raw brake sensor signal 168 and a third processed sensor signal 162 to the monitoring controller 123. This provides additional bases for comparison of these sensed values to those of raw brake sensor signals 164 and/or 166 and or the processed sensor signals 162 received by controllers 120,122. This information will enable additional comparisons and tests between these values and provide a basis for providing enhanced redundancy and fault tolerance of system 100 as a whole, as well as specifically ensuring enhanced redundancy and fault tolerance related to the values of the sensed signals received by controllers 120,122. For example, raw brake sensor signal 168 and the additional value of processed sensor signal 162 provide additional voting members which are then available for the application of well known voting techniques for ascertaining the correct value to use for the development of brake control commands by controllers 120,122 in the event that there is a discrepancy between the values of either the raw or processed sensor signals received by either of them or controller 123, such as might be caused by an undesired event associated with one of signal lines 161,164,166,168.

Referring to FIGS. 3-5, as described herein, the primary function of monitoring controller 123 is to monitor the operation of system 100, particularly controllers 120,122 and brake control buses 142,144 to ensure that all of the elements of system 100 either operate normally or else fail-silent in response to an undesired event occurring therein. It generally does not provide direct control of system 100 or the elements thereof or serve as a replacement or back-up for either of controllers 120,122 with respect to their supervisory authority in response to undesired events occurring therein. However, for certain undesired events, such as those occurring in either of controllers 120,122 or their respective brake control buses 142,144, there may be uncertainty associated with the fail-silent status of their respective brake control unit pairs 134,136 or 138,140. In order to ensure the fail-silent operation of one of the first pair of brake control units 134,136 or the second pair of brake control units 138,140 in such circumstances, it is preferred that monitoring controller 123 be adapted to provide limited control functionality to affect the fail-silent operation of one of the first pair of brake control units and the second pair of brake control units. This may be accomplished by adapting monitoring controller 123 to provide a disabling or cutoff control command or signal to one of the brake control unit pairs or one of the bus controls in the case of an event that requires that it exercise limited control authority. This limited control authority is accomplished by introducing a means for disabling one of the first pair of brake control units and the second pair of brake control units, such as brake control cutoff module 176, that is adapted to receive the disabling or cutoff control command or signal from the monitoring controller and provide a control output that is adapted to cause the fail-silent operation or disabling of one of the first pair of brake control units and the second pair of brake control units. This may be accomplished either directly by affecting control of one of the brake control unit pairs (see FIG. 3) or indirectly by affecting control of the brake control bus associated with such pair, such as through one of the bus controls 184,186. The indirect method relies on the fail-silent design of the brake control unit, such that its associated control module is adapted to affect the fail-silent operation of the brake control unit in the event that bus communication is interrupted. It is an important feature of the means for disabling, such as brake control cutoff module 176, that it be adapted so as to only affect control of one of the brake control unit pairs at a time, such that both brake control unit pairs may not be disabled simultaneously by the action of monitoring controller 123.

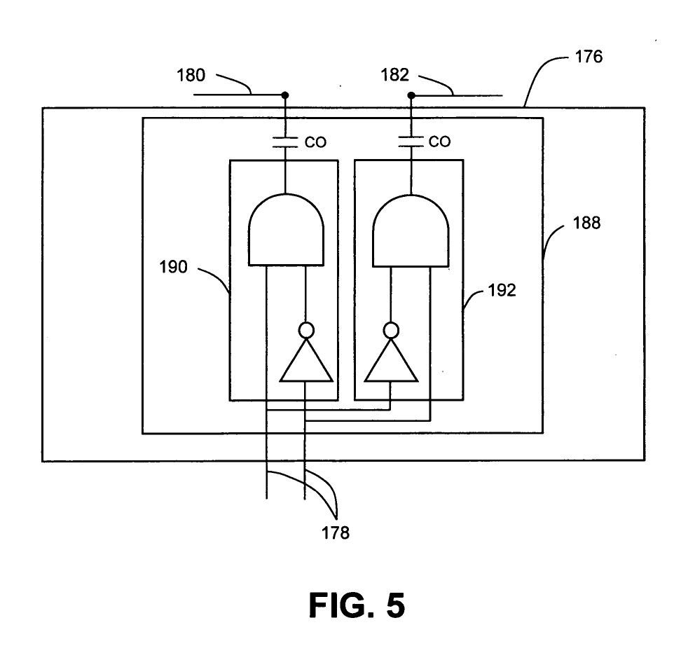

Control of the brake control units pairs or brake control buses may be accomplished by any suitable means for disabling (i.e., causing the fail-silent operation of) these devices. One means for ensuring their fail-silent operation is brake control cutoff module 176 shown in FIGS. 3-5. In one embodiment brake control cutoff module 176 comprises a latching logic relay 188 having a first AND NOT combination of logic gates 190 and a second AND NOT combination of logic gates 192, wherein each of the NOT gates is associated with an opposite input of the AND gates, as shown in FIG. 5. First logic combination 190 and second logic combination 192 are interconnected such that each is adapted to provide an output in response to a control command from controller 123 associated with one of the pairs of brake control units. It is preferred that these logic combinations comprise separate logic networks so as to provide enhanced redundancy with regard to certain common mode event mechanisms. When using latching logic relay 188 as the means for ensuring the fail-silent operation of one of the pairs of brake control units, it is desirable that first brake control signal line 180 and second brake control signal line 182 comprise hardwired logic lines. As shown in FIG. 3, logic combination 190 is adapted to receive an input in the form of a control signal or signals 178 from controller 123 and provide an output so as to latch relay 188 closed on brake control line 180, such as a hardwired logic line, for the purpose of communicating a signal to the first pair of brake control units 134,136. In the case of a hardwired logic line this may comprise, for example, changing the state of this line from enabled to disabled. Similarly, logic combination 192 is adapted to receive an input in the form of a control signal or signals 178 from controller 123 and provide an output so as to latch relay 188 closed on brake control line 182, such as hardwired logic line, for the purpose of communicating a signal to the second pair of brake control units 138,140. As shown in FIG. 4, logic combination 190 is adapted to receive an input in the form of a control signal or signals 178 from controller 123 and provide an output so as to latch relay 188 closed on brake control line 180, such as a hardwired logic line, for the purpose of communicating a signal to first bus control 184. In the case of a hardwired logic line this may comprise, for example, changing the state of this line from enabled to disabled and causing bus control 184 to disable bus 142. Similarly, logic combination 192 is adapted to receive an input in the form of a control signal or signals 178 from controller 123 and provide an output so as to latch relay 188 closed on brake control line 182, such as hardwired logic line, for the purpose of communicating a signal to second bus control 186.

The use of a latching relay 188 and logic combinations 190 and 192 illustrate one means for ensuring that only one of the brake control unit pairs may be disabled by monitoring controller 123 at any time, thereby insuring both the fail-silent operation of system 100 and fault tolerance with regard to the braking function by insuring that one-half of the braking function will be maintained in response to any single point event occurring within system 100, and particularly within controllers 120,122,123 or brake control buses 142,144.

Referring now to FIGS. 3-5, the combination of supervisory controller 120 and monitoring controller 123 comprise a first fail-silent pair. Likewise, the combination of supervisory controller 122 and monitoring controller 123 comprise a second fail-silent pair. The following description illustrates the operation of system 100 and certain of its fault tolerance and redundancy features.

Referring to FIGS. 3-4, in response to an event related to any single brake control unit, supervisory controllers 120,122 will detect the event using vehicle dynamics information and known methods of event detection and turn off the other member of the brake control unit pair and system 100 will maintain one-half of its braking function.

If an event affects the monitoring function in monitoring controller 123, supervisory controllers 120,122 will detect the event using various known methods, such as sanity checks related to the information which is shared among them, and an appropriate control action can be taken, such as, for example, issuing a warning message to the vehicle operator, but full braking functionality will be maintained. If controller 123 becomes inoperative (i.e. more than a loss of its monitoring function), this will be detected by supervisory controllers 120,122 and full braking functionality will be maintained. Controllers 120,122 will maintain control of the brake system and an appropriate control action may be taken, for example, issuing a warning message to the vehicle operator. If an undesired event affects the portion of monitoring controller 123 which directs the output on signal line 178, it is possible that one-half of the braking function may be disabled as a result.

If an undesired event occurs in one of supervisory controllers 120,122, it will be detected by monitoring controller 123 through diagnostics, shared sensors, and monitoring and either the controller in which the event occurs will cause the shutdown of the braking function for its half of system 100, or the brake control cutoff module will be activated by monitoring controller 123 so as to disable the half of system 100 controlled by this controller, and one-half of the braking function will be maintained.

In the case of an event related to one of brake control buses 142,144 all controllers 120,122,123 detect the event since they all monitor the bus activity. In the case of an event related to brake control bus 142 or brake control bus 144, the brake control units controlled through the bus in which the event occurs will be turned off either by action of the supervisory controller, or the fail-silent design features of the brake control units or by action of the monitoring controller 123 and activation of brake control cutoff module 176. In any case, one-half of the braking function will be maintained.

If the case of an event related to controller bus 146, all controllers detect the event since they all monitor the activity of controller bus 146. Assuming that controllers 120,122 are operating normally, they will continue to control their respective brake control units and monitoring controller 123 will monitor the communications over brake controls buses 142,144 for evidence of any events related to either of controllers 120,122 or brake control buses 142,144. If no event is detected, the full braking function of system 100 will be maintained. If an event is detected by controller 123, it will activate the brake control cutoff module to disable the brake control unit pair associated with the portion in which the event occurs, and one-half of the braking function of system 100 will be maintained.

From the above description, it is clear that system 100 provides dual fail-silent pair architecture which assures that at least half of the braking functionality is maintained under any single point event.

Further scope of applicability of the present invention will become apparent from the drawings and this detailed description, as well as the following claims. However, it should be understood that the detailed description and specific examples, while indicating preferred embodiments of the invention, are given by way of illustration only, since various changes and modifications within the spirit and scope of the invention will become apparent to those skilled in the art.

1. A brake control system, comprising:
a first pair of brake control units;
a second pair of brake control units;
a first brake control bus which is operatively connected to each of the respective ones of said first pair of brake control units;
a second brake control bus which is operatively connected to each of the respective ones of said second pair of brake control units;
a first supervisory controller which is operatively connected to said first brake control bus and adapted to control each of the respective ones of said first brake control unit pair through said first control bus;
a second supervisory controller which is operatively connected to said second brake control bus and adapted to control each of the respect ones of said second brake control unit pair through said second control bus;
a controller bus which is operatively connected to each of said first supervisory controller and said second supervisory controller; and
a monitoring controller which is operatively connected to said controller bus and adapted to monitor the performance of said first supervisory controller, said second supervisory controller, said first brake control bus, and said second brake control bus.

2. The brake control system of claim 1, further comprising a brake control cutoff module, said module operatively connected by at least one controller signal line to said monitoring controller, said module also operatively connected by a first brake control line to said first pair of brake control units and by a second brake control line to said second pair of brake control units, wherein said brake control cutoff module is adapted to receive a control input signal from said monitoring controller and selectively provide a control output signal to one of said first brake control unit pair and said second brake control unit pair, and wherein the control output signal comprises a cutoff command to the one of said pairs receiving the control output signal.

3. The brake control system of claim 2, wherein the brake control cutoff module comprises a latching relay having embedded control logic to control the latching of the relay.

4. The brake control system of claim 3, wherein the control output signal is selectively provided to one of said first pair of brake control units and said second pair of brake control units in accordance with the control logic.

5. The brake control system of claim 4, wherein the at least one signal line comprises a first logic line and a second logic line, and wherein the first logic line may be selectively operatively connected through the control logic to the first brake control line and the second logic line may be selectively operatively connected through the logic to the second brake control line.

6. The brake control system of claim 1, further comprising a brake control cutoff module, said module operatively connected by at least one controller signal line to said monitoring controller, said module also operatively connected by a first brake control line to a first bus control which is operatively connected to said first brake bus and by a second brake control line to a second bus control which is operatively connected to said second brake bus, wherein said brake control cutoff module is adapted to receive a control input signal from said monitoring controller and selectively provide a control output signal to one of said first bus control and said second bus control, and wherein the control output signal comprises a cutoff command to the one of said first bus control and said second bus control receiving the control output signal.

7. The brake control system of claim 6, wherein the brake control cutoff module comprises a latching relay having embedded control logic to control the latching of the relay.

8. The brake control system of claim 7, wherein the control output signal is selectively provided to one of said first bus control and said second bus control in accordance with the control logic.

9. The brake control system of claim 8, wherein the at least one signal line comprises a first logic line and a second logic line, and wherein the first logic line may be selectively operatively connected through the control logic to the first brake control line and the second logic line may be selectively operatively connected through the control logic to the second brake control line.

10. The brake control system of claim 1, further comprising a means for selectively disabling one of said first pair of brake control units and said second pair of brake control units, said means in signal communication with said monitoring controller, said means connected by a first signal line to and in signal communication with said first pair of brake control units and connected by a second signal line to and in signal communication with said second pair of brake control units, said means adapted to receive a control input signal from said monitoring controller and communicate a control output signal in response thereto to disable one of said first brake control unit pair and said second brake control unit pair.

11. The brake control system of claim 1, wherein said monitoring controller is adapted to provide a warning indication to an operator in the event that one of said first brake control unit pair and said second brake control unit pair is disabled.

12. The brake control system of claim 1, wherein said first supervisory controller and said monitoring controller comprise a first fail-silent pair and said second supervisory controller and said monitoring controller comprise a second fail-silent pair.

13. The brake control system of claim 1, further comprising:
a first brake sensor that is operatively connected to a brake actuation device and adapted to sense an operator input and provide a first unprocessed brake signal,
a second brake sensor that is operatively connected to the brake actuation device and adapted to sense the operator input and provide a second unprocessed brake signal;
a third brake sensor that is operatively connected to the brake actuation device and adapted to sense the operator input and provide a third unprocessed brake signal;
a brake actuation module that is adapted to receive the first unprocessed brake signal, second unprocessed brake signal and third unprocessed brake signal and process these output signals to provide a processed brake signal, wherein said first supervisory controller is adapted to receive the first unprocessed brake signal and the processed brake signal and is adapted to control said first brake control unit pair in response thereto, and said second supervisory controller is adapted to receive the second unprocessed brake signal and the processed brake signal and is adapted to control said second brake control unit pair in response thereto, and said monitoring controller is adapted to receive the third unprocessed brake signal and the processed brake signal.

14. A brake control system, comprising:
a first pair of brake control units;
a second pair of brake control units;
a first brake control bus which is operatively connected to each of the respective ones of said first pair of brake control units;
a second brake control bus which is operatively connected to each of the respective ones of said second pair of brake control units;
a first supervisory controller which is operatively connected to said first brake control bus and adapted to control each of the respective ones of said first brake control unit pair through said first control bus;
a second supervisory controller which is operatively connected to said second brake control bus and adapted to control each of the respect ones of said second brake control unit pair through said second control bus;
a controller bus which is operatively connected to each of said first supervisory controller and said second supervisory controller, and
a monitoring controller which is operatively connected to said controller bus and adapted to monitor the performance of said first supervisory controller, said second supervisory controller, said first brake control bus, and said second brake control bus; and
a brake control cutoff module, said module operatively connected by at least one controller signal line to said monitoring controller, said module also operatively connected by a first brake control line to said first pair of brake control units and by a second brake control line to said second pair of brake control units, wherein said brake control cutoff module is adapted to receive a control input signal from said monitoring controller and selectively provide a control output signal to one of said first brake control unit pair and said second brake control unit pair, and wherein the control output signal comprises a cutoff command to the one of said pairs receiving the control output signal.

15. The brake control system of claim 14, further comprising:
a first brake sensor that is operatively connected to a brake actuation device and adapted to sense an operator input and provide a first unprocessed brake signal,
a second brake sensor that is operatively connected to the brake actuation device and adapted to sense the operator input and provide a second unprocessed brake signal;
a third brake sensor that is operatively connected to the brake actuation device and adapted to sense the operator input and provide a third unprocessed brake signal;
a brake actuator module that is adapted to receive the first unprocessed brake signal, second unprocessed brake signal and third unprocessed brake signal and process these output signals to provide a processed brake signal, wherein said first supervisory controller is adapted to receive the first unprocessed brake signal and the processed brake signal and is adapted to control said first brake control unit pair in response thereto, and said second supervisory controller is adapted to receive the second unprocessed brake signal and the processed brake signal and is adapted to control said second brake control unit pair in response thereto, and said monitoring controller is adapted to receive the third unprocessed brake signal and the processed brake signal.

16. The brake control system of claim 15, wherein said first supervisory controller and said monitoring controller comprise a first fail-silent pair and said second supervisory controller and said monitoring controller comprise a second fail-silent pair.

17. A brake control system, comprising:
a first pair of brake control units;
a second pair of brake control units;
a first brake control bus which is operatively connected to each of the respective ones of said first pair of brake control units;
a second brake control bus which is operatively connected to each of the respective ones of said second pair of brake control units;
a first supervisory controller which is operatively connected to said first brake control bus and adapted to control each of the respective ones of said first brake control unit pair through said first control bus;
a second supervisory controller which is operatively connected to said second brake control bus and adapted to control each of the respect ones of said second brake control unit pair through said second control bus;
a controller bus which is operatively connected to each of said first supervisory controller and said second supervisory controller;
a monitoring controller which is operatively connected to said controller bus and adapted to monitor the performance of said first supervisory controller, said second supervisory controller, said first brake control bus, and said second brake control bus; and
a brake control cutoff module, said module operatively connected by at least one controller signal line to said monitoring controller, said module also operatively connected by a first brake control line to a first bus control which is operatively connected to said first brake bus and by a second brake control line to a second bus control which is operatively connected to said second brake bus, wherein said brake control cutoff module is adapted to receive a control input signal from said monitoring controller and selectively provide a control output signal to one of said first bus control and said second bus control, and wherein the control output signal comprises a cutoff command to the one of said first bus control and said second bus control receiving the control output signal.

18. The brake control system of claim 17, further comprising:
a first brake sensor that is operatively connected to a brake actuation device and adapted to sense an operator input and provide a first unprocessed brake signal,
a second brake sensor that is operatively connected to the brake actuation device and adapted to sense the operator input and provide a second unprocessed brake signal;
a third brake sensor that is operatively connected to the brake actuation device and adapted to sense the operator input and provide a third unprocessed brake signal;
a brake actuator module that is adapted to receive the first unprocessed brake signal, second unprocessed brake signal and third unprocessed brake signal and process these output signals to provide a processed brake signal, wherein said first supervisory controller is adapted to receive the first unprocessed brake signal and the processed brake signal and is adapted to control said first brake control unit pair in response thereto, and said second supervisory controller is adapted to receive the second unprocessed brake signal and the processed brake signal and is adapted to control said second brake control unit pair in response thereto, and said monitoring controller is adapted to receive the third unprocessed brake signal and the processed brake signal.

19. The brake control system of claim 18, wherein said first supervisory controller and said monitoring controller comprise a first fail-silent pair and said second supervisory controller and said monitoring controller comprise a second fail-silent pair.

20. The brake control system of claim 1, further comprising a brake control cutoff module, said module operatively connected by at least one controller signal line to said monitoring controller, said module also operatively connected by a first brake control signal line in signal communication with said first pair of brake control units and by a second brake control signal line in signal communication with said second pair of brake control units, wherein said brake control cutoff module is adapted to receive a control input signal from said monitoring controller and selectively provide a control output signal to one of said first pair of brake control units and second pair of brake control units, and wherein the control output signal comprises a cutoff command to the one of said first pair of brake control units and second pair of brake control units receiving the control output signal.

21. The brake control system of claim 20 wherein said first brake control signal line is operatively connected to said first pair of brake control units through a first bus control and said second brake control signal line is operatively connected to said second pair of brake control units through a second bus control.

22. The brake control system of claim 20 wherein said first brake control signal line is directly operatively connected to said first pair of brake control units and said second brake control signal line is directly operatively connected to said second pair of brake control units.
